(19) United States
(12) Patent Application Publication
(10) Pub. No.: US 2020/0323306 A1
(43) Pub. Date: Oct. 15, 2020

(54) Personal Earthing Strap

(71) Applicant: Earthling 3.0 Pty Ltd., Pasadena (AU)

(72) Inventor: George Ioannou, Pasadena (AU)

(73) Assignee: Earthling 3.0 Pty Ltd., Pasadena (AU)

(21) Appl. No.: 16/848,817

(22) Filed: Apr. 14, 2020

(30) Foreign Application Priority Data
Apr. 15, 2019 (AU) 2019901293

(51) Int. Cl. A43B 7/36

(52) U.S. Cl. CPC A43B 7/36; H05F 3/02

(57) ABSTRACT

A personal earthing strap comprising multiple layers with different characteristics to give the strap durability and high conductivity. The uppermost conductive layer sits under a perforated top layer which can be printed on whilst allowing contact with the conductive layer.

### CROSS-REFERENCES TO RELATED APPLICATIONS

This application claims priority from Australian Application Serial Number 2019901293 filed Apr. 15, 2019, which is hereby incorporated herein by reference in the respective in its entirety.

### FIELD OF THE INVENTION

The present invention relates to a personal earthing strap, typically fitted to a shoe, with improved printability and durability.

### BACKGROUND TO THE INVENTION

Personal earthing straps are used to continuously discharge static electricity from a person. This prevents a person from suffering shock when coming into contact with objects and has been reported in journals as improving activity of the vagus nerve, which regulates the body at rest, including heart rate, vein diameter, and activity in the heart, lungs, and digestive tract.

Earthing straps such as that disclosed in Australian Patent Application 2017202352, have been found to be effective, but lack durability and the ability to be printed on for branding purposes. This is primarily because the conductive layer is on the top layer of the strap. To achieve a conductive plastic element suitable for making a strap carbon is added to the plastic. High levels of carbon are desirable to make the strap more conductive, however doing so makes the strap more brittle. High carbon plastics also have problems retaining ink printed onto them, making branding difficult.

The object of this invention is to provide a personal earthing strap to alleviate the above problems, or at least provide the public with a useful alternative.

### SUMMARY OF THE INVENTION

In a first aspect the invention provides a personal earthing strap comprising at least one conductive layer and a top layer, wherein the top layer is formed from a material that accepts printing, and wherein the top layer is perforated to allow contact with a conductive layer beneath it.

Preferably the strap comprises a plurality of conductive layers held together with double sided conductive adhesive, wherein a first conductive layer comprises a relatively high proportion of carbon to provide a relatively low surface conductivity, and a second conductive layer comprises a relatively low proportion of carbon to provide a relatively high surface conductivity.

It should be noted that any one of the aspects mentioned above may include any of the features of any of the other aspects mentioned above and may include any of the features of any of the embodiments described below as appropriate.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows.

FIG. 1 shows a top view of an earthing strap according to the present invention.

FIG. 2 shows a cross sectional view of the earthing strap.

FIG. 3 shows a top view of a portion of the top layer of the earthing strap.

FIG. 4 shows a side view of a shoe with the earthing strap fitted.

FIG. 5 is a cross sectional view of the shoe with earthing strap fitted of FIG. 4.

### DRAWING COMPONENTS

The drawings include the following integers.
10 earthing strap
12 shoe end section
14 joining section
16 ground end section
18 printed logo
20 perforated top layer
22 perforations
25 first conductive layer
30 double sided conductive adhesive
35 second conductive layer
40 double sided conductive adhesive
45 energy absorbing layer
50 transfer adhesive
55 lateral strength layer
60 double sided adhesive
65 adhesive liner
100 shoe
102 sole
104 inner sole
106 side wall

### DETAILED DESCRIPTION OF THE INVENTION

The following detailed description of the invention refers to the accompanying drawings. Wherever possible, the same reference numbers will be used throughout the drawings and the following description to refer to the same and like parts. Dimensions of certain parts shown in the drawings may have been modified and/or exaggerated for the purposes of clarity or illustration.

The present invention provides a personal earthing strap comprising multiple layers with different characteristics to give the strap durability and high conductivity. The uppermost conductive layer sits under a perforated top layer which can be printed on and allows contact with the conductive layer.

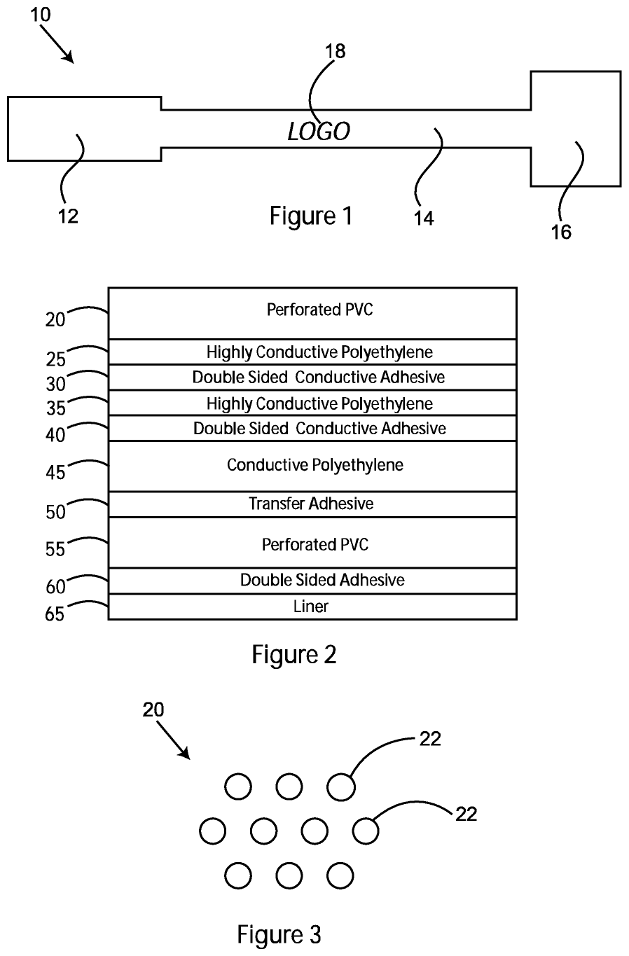

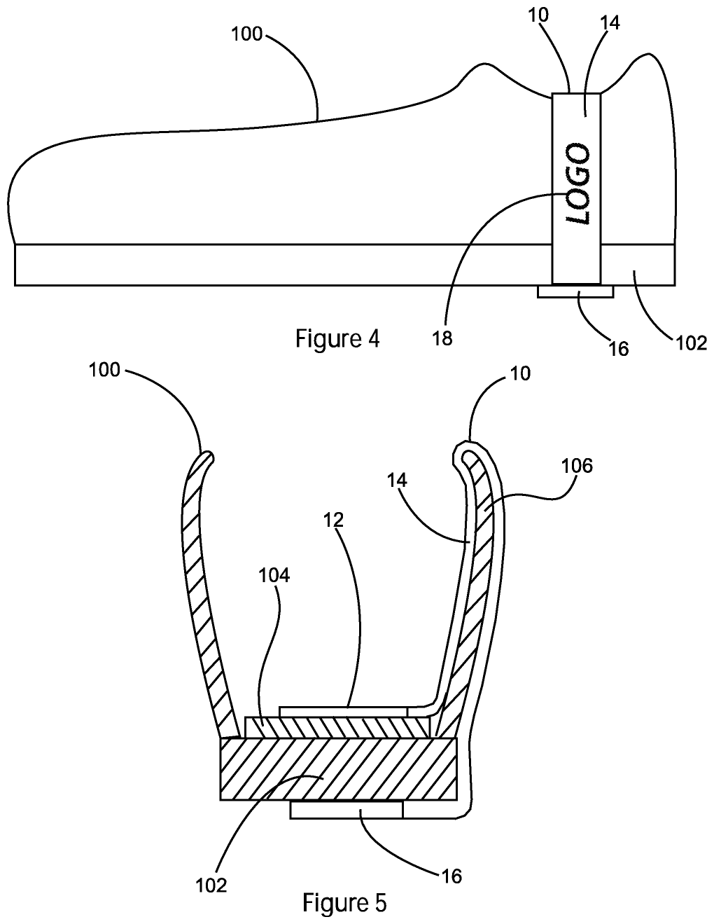

An earthing strap 10 according to the invention is shown from above in FIG. 1. The strap 10 is approximately 150 mm long and 4 mm thick and comprises a shoe end section 12 which in use is positioned on the top of the inner sole of a shoe, a ground end section 14 normally which in use is positioned under the sole of a shoe, and a joining section 16 which joins the shoe end section to the ground end section. The strap is attached to the shoe via double sided adhesive and is generally conductive to allow static to be discharged from a foot in contact with the foot end section to earth via the ground end section. The top layer of the strap can be printed on to include a logo 18. The strap is shown fitted to a shoe 100 in FIG. 4 and FIG. 5 which are discussed further below.

The strap 10 comprises a series of layers which can be appreciated with the cross sectional view of FIG. 2. The vertical scale of FIG. 2 is greatly exaggerated to allow the composition of the strap to be appreciated, likewise the relative height of some layers are exaggerated. Whilst all layers aid in providing a mechanically robust strap they fall roughly into three categories: a top layer to support printing; multiple conductive layers; and a series of layers to provide mechanical strength and adhesion.

The various layers may be formed from a variety of materials with appropriate properties. Polyvinyl chloride (PVC) is preferably used for most layers to provide strength and flexibility. The conductive layers are preferably polyethylene impregnated with carbon.

The perforated top layer 20 is formed from 0.2 mm thick PVC with a series of 1.5 mm perforations 22 separated from each other by 1.5 mm as shown in FIG. 3. This arrangement of perforations maintains strength whilst allowing contact with the first conductive layer 25 below. The top layer can be printed on, with the ink adhering to the spaces between the perforations. At a distance the perforations are un-noticeable, allowing for the clear display of a logo 18 or the like. The top layer is coated underneath with a non-conductive adhesive.

Beneath the perforated top layer 20 sits first and second highly conductive layers 25, 35 held together with a double sided conductive adhesive 30. The conductive layers 25, 35 are formed from a polyethylene file approximately 0.1 mm thick and impregnated with carbon to give a surface resistivity of approximately 200 Ω/sq. Before assembly the conductive layers are primed to promote adhesion with an acetone primer. A further layer of double sided conductive adhesive 40 sits between the second conductive 35 layer and an energy absorbing layer 45 which is also a lightly conductive layer. The energy absorbing layer is a polyethylene file approximately 0.2 mm thick and lightly impregnated with carbon to give a surface resistivity of approximately 200 kΩ/sq. This adds to the overall conductivity to the strap whilst still remaining flexible. The relatively low carbon content of the energy absorbing layer in comparison to the first and second conductive layers, allows it to stay suitably flexible for absorbing loads. The energy absorbing layer is also primed before assembly.

Beneath the conductive layers sits a transfer adhesive layer 50 which attaches a lateral strength layer 55 comprising approximately 0.3 mm thick perforated PVC to give lateral strength to the strap. The strength layer is a semi-rigid PVC to add some structure to the strap.

Finally beneath the lateral strength layer sits a layer of double sided adhesive 60 to attach the strap to a shoe. Before use the adhesive layer is protected by an adhesive liner 65 which is easily peeled off when desired.

The combination of the various layers used has been found to provide both higher conductivity and superior durability to the strap when compared to a strap that comprises a single conductive layer and a single strength layer. The perforated also adds to the durability whilst allowing the strap to be printed upon.

FIG. 4 shows a side view of a shoe 100 with a strap 10 fitted, with FIG. 5 showing a cross sectional view. To fit the strap 10 to the shoe, the adhesive protector layer 65 is first removed and then strap pressed against the shoe as shown with the double sided adhesive layer 60 in contact with the shoe. The shoe end section 12 is positioned on the top of the inner sole 104 of the shoe; the joining section 16 is run across the inner sole 104, up the inside of and down the outside of the side 106 of the shoe, and across the sole 102 of the shoe. The ground end section 14 is positioned under the sole of the shoe. The shoe end section is typically positioned first as its location will affect the comfort of the user. Once the strap is in position the loo 18 is prominently facing outward from the side of the shoe.

The reader will now appreciate the present invention which provides an effective personal earth strap that is both durable and printable.

Further advantages and improvements may very well be made to the present invention without deviating from its scope. Although the invention has been shown and described in what is conceived to be the most practical and preferred embodiment, it is recognized that departures may be made therefrom within the scope of the invention, which is not to be limited to the details disclosed herein but is to be accorded the full scope of the claims so as to embrace any and all equivalent devices and apparatus. Any discussion of the prior art throughout the specification should in no way be considered as an admission that such prior art is widely known or forms part of the common general knowledge in this field.

In the present specification and claims (if any), the word “comprising” and its derivatives including “comprises” and “comprise” include each of the stated integers but does not exclude the inclusion of one or more further integers.

1. A personal earthing strap comprising at least one conductive layer and a top layer, wherein the top layer is formed from a material that accepts printing, and wherein the top layer is perforated to allow contact with a conductive layer beneath it.

2. The personal earthing strap as in claim 1, wherein the strap comprises a plurality of conductive layers held together with double sided conductive adhesive.

3. The personal earthing strap as in claim 1, wherein a first conductive layer comprises a relatively high proportion of carbon to provide a relatively low surface conductivity, and a second conductive layer comprises a relatively low proportion of carbon to provide a relatively high surface conductivity.

4. The personal earthing strap as in claim 2, wherein a first conductive layer comprises a relatively high proportion of carbon to provide a relatively low surface conductivity, and a second conductive layer comprises a relatively low proportion of carbon to provide a relatively high surface conductivity.
